(19) United States
(12) Patent Application Publication
(10) Pub. No.: US 2024/0332607 A1
(43) Pub. Date: Oct. 3, 2024

(54) SOLID ELECTROLYTE SHEET AND ALL-SOLID-STATE BATTERY

(71) Applicant: HONDA MOTOR CO., LTD., Tokyo (JP)

(72) Inventors: Yohei NOJI, Saitama (JP); Akihiro YOSHIZAWA, Saitama (JP); Takahiro MACHIDA, Saitama (JP); Nanae TERADO, Saitama (JP); Kosei MIYATA, Saitama (JP)

(21) Appl. No.: 18/621,130

(22) Filed: Mar. 29, 2024

(30) Foreign Application Priority Data
Mar. 31, 2023 (JP) 2023-059615

(51) Int. Cl. H01M 10/0562; H01M 10/0525; H01M 50/443; H01M 50/446; H01M 50/457; H01M 50/491

(52) U.S. Cl. CPC H01M 10/0562; H01M 10/0525; H01M 50/443; H01M 50/446; H01M 50/457; H01M 50/491; H01M 2300/0094

(57) ABSTRACT

The solid electrolyte sheet of the present invention includes an inner layer, a first outer layer stacked on one surface of the inner layer, and a second outer layer stacked on the other surface of the inner layer. The inner layer includes a porous base material and an inner layer solid electrolyte composition filled in the porous base material. The inner layer solid electrolyte composition contains a solid electrolyte material and a binder. The first outer layer includes a first outer layer solid electrolyte composition containing a solid electrolyte material and a binder. The second outer layer includes a second outer layer solid electrolyte composition containing a solid electrolyte material and a binder.

This application is based on and claims the benefit of priority from Japanese Patent Application No. 2023-059615, filed on 31 Mar. 2023, the content of which is incorporated herein by reference.

### BACKGROUND OF THE INVENTION

### Field of the Invention

The present invention relates to a solid electrolyte sheet and an all-solid-state battery.

### Related Art

In recent years, research and development have been conducted on all-solid-state batteries to contribute to the efficiency of energy usage, with the aim of ensuring more people have access to affordable, reliable, sustainable, and advanced energy. An all-solid-state battery typically has a structure that includes a solid electrolyte layer interposed between a positive electrode and a negative electrode. For instance, in a lithium-ion all-solid-state battery, the solid electrolyte layer functions both as a conductor of lithium ions and as a separator to prevent short circuits between the positive electrode layer (positive electrode active material layer) within the positive electrode and the negative electrode layer (negative electrode active material layer) within the negative electrode. Here, the solid electrolyte layer serving as a separator should desirably be as thin as possible to enhance energy density. However, merely thinning the layer may lead to decreased strength and occurrence of cracks; therefore, an all-solid-state battery that contains a porous base material to ensure both thinning a solid electrolyte layer and enhancing strength are known (refer to Patent Document 1 etc.).
Patent Document 1: Japanese Unexamined Patent Application, Publication No. 2015-153460

### SUMMARY OF THE INVENTION

Challenges in the technology related to all-solid-state batteries include long-term stability and improvement in charge and discharge efficiency. The inclusion of a porous base material improves the strength of the solid electrolyte layer, enhancing the stability of the all-solid-state battery. However, the use of a porous base material may lead to issues such as uneven strength distribution; and cracks may occur or ionic conductivity may be reduced by containing a porous base material.

The present application mainly aims to solve these issues by providing a solid electrolyte sheet with improved strength, suppressed crack formation, and enhanced ion conductivity, as well as an all-solid-state battery having a solid electrolyte layer with improved strength, suppressed crack formation, and enhanced ion conductivity. This, in turn, contributes to the efficiency of energy usage.

The inventors have completed the present invention by finding that, in order to solve the above problems, it is effective to adjust the particle size of the solid electrolyte material and the amount of binder used in both the inner layer and the outer layer of the solid electrolyte sheet, in which the inner layer is filled with a solid electrolyte composition containing a solid electrolyte material and a binder in a porous base material, and the outer layer contains a solid electrolyte composition stacked on the surface of the inner layer. Consequently, the present invention provides the following.

(1) A solid electrolyte sheet includes an inner layer, a first outer layer stacked on one surface of the inner layer, and a second outer layer stacked on the other surface of the inner layer. The inner layer includes a porous base material and an inner layer solid electrolyte composition filled in the porous base material. The inner layer solid electrolyte composition contains a solid electrolyte material and a binder. The first outer layer includes a first outer layer solid electrolyte composition containing a solid electrolyte material and a binder. The second outer layer includes a second outer layer solid electrolyte composition containing a solid electrolyte material and a binder. The inner layer solid electrolyte composition has a binder content ratio that is higher than a binder content ratio of the first outer layer solid electrolyte composition and higher than a binder content ratio of the second outer layer solid electrolyte composition. The solid electrolyte material contained in the inner layer solid electrolyte composition has an average particle size that is smaller than an average particle size of the solid electrolyte material contained in the first outer layer solid electrolyte composition and smaller than an average particle size of the solid electrolyte material contained in the second outer layer solid electrolyte composition.

With the solid electrolyte sheet as described in (1), the inner layer solid electrolyte composition has a high binder content ratio, enhancing adhesion to the porous base material of the inner layer, thus reducing the likelihood of crack formation. Meanwhile, the first and second outer layer solid electrolyte compositions each have a lower binder content ratio, improving ion conductivity. Additionally, the inner layer solid electrolyte composition, having a smaller average particle size of the solid electrolyte material, fills the porous base material of the inner layer more easily and densely, improving the strength of the solid electrolyte sheet and the effectiveness in preventing cracks. Furthermore, the larger average particle size of the solid electrolyte material in the first outer layer composition and the larger average particle size of the solid electrolyte material in the second outer layer composition enhances the lithium-ion conductivity of the solid electrolyte sheet. Therefore, the solid electrolyte sheet as described in (1) improves strength, suppresses crack formation, and enhances the ion conductivity.

(2) The solid electrolyte sheet as described in (1), in which the binder content ratio of the first outer layer solid electrolyte composition and the binder content ratio of the second outer layer solid electrolyte composition are each within a range of 1/10 to 9/10 of the binder content ratio of the inner layer solid electrolyte composition.

With the solid electrolyte sheet as described in (2), since the binder content ratios in the inner layer solid electrolyte composition, the first outer layer solid electrolyte composition, and the second outer layer solid electrolyte composition are in the above relationship, the strength of the solid electrolyte sheet, the effectiveness in preventing crack formation, and the lithium-ion conductivity are improved in a more balanced manner.

(3) The solid electrolyte sheet as described in (2), in which the binder content ratio of the first outer layer solid electrolyte composition and the binder content ratio of the second outer layer solid electrolyte composition are each within a range of 3/10 to 6/10 of the binder content ratio of the inner layer solid electrolyte composition.

With the solid electrolyte sheet as described in (3), since the binder content ratios in the inner layer solid electrolyte composition, the first outer layer solid electrolyte composition, and the second outer layer solid electrolyte composition are in the above relationship, the strength of the solid electrolyte sheet, the effectiveness in preventing crack formation, and the lithium-ion conductivity are improved in a further more balanced manner.

(4) The solid electrolyte sheet as described in any one of (1) to (3), in which the binder content ratio of the inner layer solid electrolyte composition is within a range of 3 to 20% by mass.

With the solid electrolyte sheet as described in (4), since the binder content ratio of the inner layer solid electrolyte composition is within the above range, the strength of the solid electrolyte sheet, the effectiveness in preventing crack formation, and the lithium-ion conductivity are further improved in a more balanced manner.

(5) The solid electrolyte sheet as described in (4), in which the binder content ratio of the inner layer solid electrolyte composition is within a range of 3 to 9% by mass.

With the solid electrolyte sheet as described in (5), since the binder content ratio of the inner layer solid electrolyte composition is within the above range, the lithium-ion conductivity is further improved.

(6) The solid electrolyte sheet as described in (5), in which the inner layer has a thickness within a range of 10 μm to 25 μm.

With the solid electrolyte sheet as described in (6), since the thickness of the inner layer is within the above range, the lithium-ion conductivity is further improved.

(7) The solid electrolyte sheet as described in (4), in which the binder content ratio of the inner layer solid electrolyte composition is within a range of 10 to 20% by mass.

With the solid electrolyte sheet as described in (7), since the binder content ratio of the inner layer solid electrolyte composition is within the above range, the strength of the solid electrolyte sheet is further improved.

(8) The solid electrolyte sheet as described in any one of (1) to (7), in which a particle size distribution of the solid electrolyte material contained in the inner layer solid electrolyte composition has a peak in a region where a particle diameter is 1 μm or less, and a particle size distribution of the solid electrolyte material contained in the first outer layer solid electrolyte composition and a particle size distribution of the solid electrolyte material contained in the second outer layer solid electrolyte composition each have a peak in a region where a particle diameter is 1 μm or less and a peak in a region where a particle diameter is 3 μm or more.

With the solid electrolyte sheet as described in (8), the inner layer solid electrolyte composition contains a large number of fine particles of the solid electrolyte material with a particle diameter of 1 μm or less, making it easier to fill the porous base material of the inner layer. Therefore, the strength of the solid electrolyte sheet and the effectiveness in preventing cracks are improved. Additionally, the first and second outer layer solid electrolyte compositions contain both fine particles of the solid electrolyte material with a particle diameter of 1 μm or less and coarse particles of the solid electrolyte material with a particle diameter of 3 μm or more, thus the presence of the fine particles between the coarse particles easily makes the first and second outer layers denser. Therefore, the lithium-ion conductivity of the solid electrolyte sheet is enhanced.

(9) The solid electrolyte sheet as described in any one of (1) to (8), in which the thickness of the inner layer is within a range of 2 μm to 30 μm, and the first outer layer and the second outer layer each have a thickness within a range of ⅕ to 2 times the thickness of the inner layer.

With the solid electrolyte sheet as described in (9), since the thicknesses of the inner layer, the first outer layer, and the second outer layer are within the above range, the strength of the solid electrolyte sheet, the effectiveness in preventing crack formation, and the lithium-ion conductivity are further improved in a more balanced manner.

(10) The solid electrolyte sheet as described in (9), in which the first outer layer and the second outer layer are each thinner than the inner layer.

With the solid electrolyte sheet as described in (10), since the first outer layer and the second outer layer are each thinner than the inner layer, the lithium-ion conductivity is further improved.

(11) The solid electrolyte sheet as described in (9), in which the thickness of the first outer layer and the thickness of the second outer layer are each within a range of ⅕ to ⅘ times the thickness of the inner layer.

With the solid electrolyte sheet as described in (11), since the thicknesses of the first and second outer layers are in the above range, the lithium-ion conductivity is further improved.

(12) The solid electrolyte sheet as described in any one of (9) to (11), in which the thickness of the inner layer is within a range of 10 μm to 25 μm.

With the solid electrolyte sheet as described in (12), since the thickness of the inner layer is within the above range, the lithium-ion conductivity is further improved, and electric resistance is reduced.

(13) An all-solid-state battery includes a positive electrode, a negative electrode, and a solid electrolyte layer arranged between the positive electrode and the negative electrode, in which the solid electrolyte layer consists of the solid electrolyte sheet as described in any one of (1) to (12), the first outer layer is arranged in contact with the positive electrode, and the second outer layer is arranged in contact with the negative electrode.

With the all-solid-state battery as described in (13), since the solid electrolyte layer is composed of the above-described solid electrolyte sheet, the strength of the solid electrolyte layer is enhanced, crack formation is suppressed, and ion conductivity is improved.

The present invention makes it possible to provide a solid electrolyte sheet with improved strength, suppressed crack formation, and enhanced ion conductivity, as well as an all-solid-state battery having a solid electrolyte layer with improved strength, suppressed crack formation, and enhanced ion conductivity.

### BRIEF DESCRIPTION OF THE DRAWINGS

FIG. 1 is a schematic cross-sectional view illustrating the configuration of an all-solid-state battery according to an embodiment of the present invention;

FIG. 2 is a cross-sectional SEM photograph of the inner layer of the solid electrolyte sheet obtained in Example 1; and

FIG. 3 is a cross-sectional SEM photograph of the first outer layer of the solid electrolyte sheet obtained in Example 1.

### DETAILED DESCRIPTION OF THE INVENTION

The following describes embodiments of the present invention.

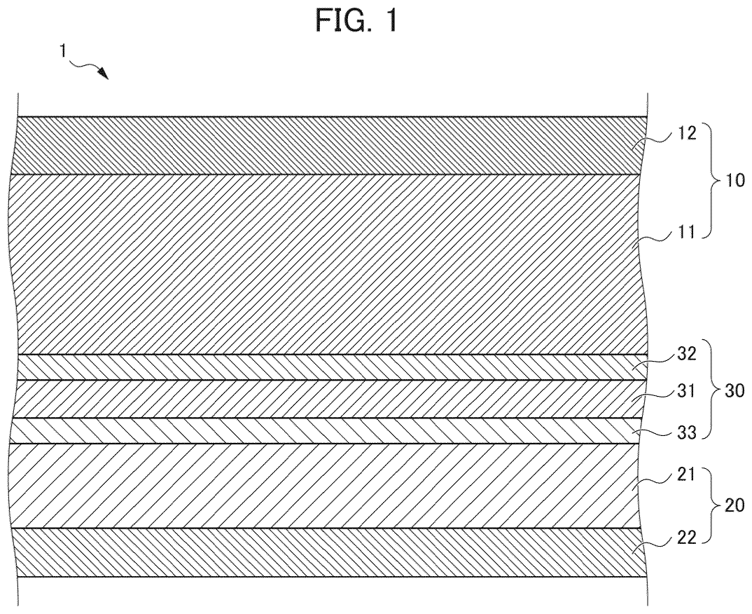

FIG. 1 is a cross-sectional view of an all-solid-state battery 1 according to an embodiment of the present invention. As illustrated in FIG. 1, the all-solid-state battery 1 includes a positive electrode 10, a negative electrode 20, and a solid electrolyte layer 30. The all-solid-state battery 1 is a laminate in which the positive electrode 10, the solid electrolyte layer 30, and the negative electrode 20 are stacked in this order. The all-solid-state battery 1 of the embodiment is a lithium-ion all-solid-state battery. In this specification, an “all-solid-state battery” refers to a battery that has been entirely solidified. The positive electrode 10 includes a positive electrode layer 11 and a positive electrode current collector 12. The positive electrode layer 11 is arranged on the side facing the solid electrolyte layer 30. The positive electrode current collector 12 forms the surface on the side of the positive electrode 10 of the all-solid-state battery 1.

The positive electrode layer 11 contains a positive electrode active material. The positive electrode active material used in the positive electrode layer 11 is not particularly limited and may be any material that functions as the positive electrode of the all-solid-state battery 1. Specific examples of positive electrode active materials include, for instance, sulfide-based materials such as titanium sulfide (TiS₂), molybdenum sulfide (MoS₂), iron sulfide (FeS, FeS₂), copper sulfide (CuS), and nickel sulfide (Ni₃S₂). Also, specific examples include, for instance, oxide-based materials such as bismuth oxide (Bi₂O₃), bismuth lead oxide (Bi₂Pb₂O₅), copper oxide (CuO), vanadium oxide (V₆O₁₃), lithium cobalt oxide (LiCoO₂), lithium nickel oxide (LiNiO₂), lithium manganese oxide (LiMnO₂), Li(NiCoMn)O₂, Li(NiCoAl)O₂, Li(NiCo)O₂, etc. A mixture of the above may also be used.

The positive electrode current collector 12 functions to collect current from the positive electrode layer 11. The positive electrode current collector 12 is a foil-shaped member made from a conductive electrode material. The electrode material used for the positive electrode current collector 12 is not particularly limited, as long as the material is conductive, and examples thereof include vanadium, aluminum, stainless steel, gold, platinum, manganese, iron, titanium, etc., with aluminum being preferred. The shape and thickness of the positive electrode current collector 12 are not particularly limited, as long as current can be collected from the positive electrode layer 11.

The negative electrode 20 includes a negative electrode layer 21 and a negative electrode current collector 22. The negative electrode layer 21 is arranged on the side facing the solid electrolyte layer 30. The negative electrode current collector 22 forms the surface on the side of the negative electrode 20 of the all-solid-state battery 1.

The negative electrode layer 21 may contain a negative electrode active material. The negative electrode active material used in the negative electrode layer 21 is not particularly limited, as long as the material functions as the negative electrode in the all-solid-state battery 1, but it is preferable to include at least one of Li-based materials or Si-based materials. Specific examples of negative electrode active materials include carbon materials, specifically, artificial graphite, graphite carbon fibers, resin-fired carbon, vapor-grown pyrolytic carbon, coke, mesocarbon microbeads (MCMB), furfuryl alcohol resin-fired carbon, polyacene, pitch-based carbon fibers, vapor-grown carbon fibers, natural graphite, non-graphitizable carbon, etc. A mixture of the above may also be used. Additionally, as a negative electrode active material, metals that form alloys with lithium, or alloys combining these metals with other elements or compounds, can be used. Examples of metals that form alloys with lithium include metal indium, metal aluminum, or metal silicon. Furthermore, metallic lithium can be used for the negative electrode layer 21.

The negative electrode current collector 22 functions to collect current from the negative electrode layer 21. The negative electrode current collector 22 is a foil-shaped member made from a conductive electrode material. The electrode material used for the negative electrode current collector 22 is not particularly limited as long as the material is conductive, and examples thereof include vanadium, stainless steel, manganese, iron, titanium, copper, nickel, cobalt, zinc, etc., among which copper and nickel are preferred due to their excellent conductivity and excellent current collectability. The shape and thickness of the negative electrode current collector 22 are not particularly limited, as long as current can be collected from the negative electrode layer 21.

The solid electrolyte layer 30 includes an inner layer 31, a first outer layer 32 stacked on one surface of the inner layer 31, and a second outer layer 33 stacked on the other surface of the inner layer 31. The first outer layer 32 is arranged in contact with the positive electrode 10, and the second outer layer 33 is arranged in contact with the negative electrode 20. The thickness of the inner layer 31 may be in the range of 2 to 30 μm or in the range of 10 to 25 μm, for example. The thicknesses of the first outer layer 32 and the second outer layer 33 may be in the range of ⅕ to 2 times the thickness of the inner layer 31, for example. From the viewpoint of improving the lithium-ion conductivity of the solid electrolyte layer 30, the thicknesses of the first outer layer 32 and the second outer layer 33 may each be smaller than the thickness of the inner layer 31, and may each be in the range of ⅕ to ⅘ times the thickness of the inner layer 31.

The inner layer 31 includes a porous base material (not illustrated) and an inner layer solid electrolyte composition (not illustrated) filled in the porous base material. The inner layer 31 may consist solely of the porous base material filled with the inner layer solid electrolyte composition. The inner layer solid electrolyte composition contains a solid electrolyte material and a binder. The inner layer solid electrolyte composition may consist solely of a solid electrolyte material and a binder.

The first outer layer 32 includes a first outer layer solid electrolyte composition containing a solid electrolyte material and a binder. The first outer layer 32 may consist solely of the first outer layer solid electrolyte composition. The second outer layer 33 includes a second outer layer solid electrolyte composition containing a solid electrolyte material and a binder. The second outer layer 33 may consist solely of the second outer layer solid electrolyte composition. The first and second outer layer solid electrolyte compositions may consist solely of a solid electrolyte material and a binder. The first and second outer layer solid electrolyte compositions may be the same.

The porous base material contained in the inner layer 31 is preferably a woven or non-woven fabric. Woven or non-woven fabrics have appropriate porosity and thickness, and are easily filled with the inner layer solid electrolyte composition. The material of the porous base material is not particularly limited, as long as the material can form a self-supporting sheet. Examples include polyethylene terephthalate (PET), polyamide (nylon), aromatic polyamide (aramid), Al₂O₃, glass, etc. The porous base material is preferably composed of heat-resistant fibers. Using heat-resistant fibers to form the porous base material allows for suppressing short circuits during manufacturing processes of the all-solid-state battery 1, such as pressing at high temperatures exceeding 200° C. Moreover, solid electrolyte layer 30 can be sintered through high-temperature pressing, which, in turn, lowers interface resistance and improves battery output. The porosity of the porous base material may be within the range of 65 to 90%. A porosity within this range allows the inner layer solid electrolyte composition to be easily filled into the interior of the porous base material.

The material used for the solid electrolyte material and binder contained in the inner layer solid electrolyte composition of the inner layer 31, the first outer layer solid electrolyte composition of the first outer layer 32, and the second outer layer solid electrolyte composition of the second outer layer 33 may be the same. Using the same material enhances the adhesion between the inner layer 31 and the first and second outer layers 32 and 33.

The solid electrolyte material should be capable of conducting lithium ions between the positive electrode 10 and the negative electrode 20, and is not particularly limited. Solid electrolyte materials can include, for example, oxide-based electrolytes or sulfide-based electrolytes. The solid electrolyte material preferably contains lithium elements. Among these, materials containing at least lithium sulfide as a first component and synthesized from one or more compounds selected from the group consisting of silicon sulfide, phosphorus sulfide, and boron sulfide as a second component are preferable, with Li₂S—P₂S₅ being particularly preferable in terms of lithium-ion conductivity.

In the case in which the solid electrolyte material is a sulfide-based electrolyte, additional sulfides such as SiS₂, GeS₂, B₂S₃, etc., may also be included. The solid electrolyte may also be appropriately supplemented with Li₃PO₄, halogens, halogen compounds, etc.

In the case in which the solid electrolyte material is an inorganic lithium-ion conductor, examples include Li₃N, LISICON, LIPON (Li_{3+y}PO₄₋ₓNₓ), Thio-LISICON (Li_{3.25}Ge_{0.25}P_{0.75}S₄), Li₂O—Al₂O₃—TiO₂—P₂O₅ (LATP), etc.

The solid electrolyte material may have structures such as amorphous, glassy, crystalline (crystallized glass), etc. In the case in which the solid electrolyte material is a sulfide-based solid electrolyte formed from Li₂S—P₂S₅, the lithium-ion conductivity of the amorphous body is about 10⁻⁴ Scm⁻¹. On the other hand, the lithium-ion conductivity in the case of the crystalline body is about 10⁻³ Scm⁻¹.

The solid electrolyte material preferably contains at least one of phosphorus or sulfur. This can improve the lithium-ion conductivity of the resulting all-solid-state battery 1.

The binder can adhere to the porous base material of the inner layer 31, the positive electrode 10, and the negative electrode 20, and can adhere the solid electrolyte material. The binder preferably contains an adhesive resin that exhibits adhesiveness. Examples of binders include fluorine-based polymer, (meth)acrylic thermoplastic resin, silicone resin, urethane resin, nitrile resin, polyester resin, cellulose resin, styrene resin, styrene-butadiene resin, vinyl acetate resin, fluorinated ethylene resin, polyvinyl ether, rubber, etc. Here, “(meth)acrylic” collectively refers to acrylic and methacrylic.

The inner layer solid electrolyte composition contained in the inner layer 31 of the solid electrolyte layer 30 has a higher binder content ratio than the first outer layer solid electrolyte composition contained in the first outer layer 32 and the second outer layer solid electrolyte composition contained in the second outer layer 33. The inner layer solid electrolyte composition, with its higher binder content ratio, increases adhesion to the porous base material. Therefore, the strength of the solid electrolyte layer 30 is enhanced. On the other hand, the first and second outer layer solid electrolyte compositions have lower binder content ratios, improving the ion conductivity of the first outer layer 32 and the second outer layer 33. Therefore, the all-solid-state battery 1 of the present embodiment can achieve both improved strength of the solid electrolyte layer 30 due to the inclusion of the porous base material and enhanced lithium-ion conductivity.

The binder content ratio in the inner layer solid electrolyte composition is not particularly limited but may be within the range of 3 to 20% by mass. The binder content ratios in the first and second outer layer solid electrolyte compositions are also not particularly limited but may each be within the range of 1/10 to 9/10 or the range of 3/10 to 6/10 of the binder content ratio of the inner layer solid electrolyte composition. Having the binder content ratios of the inner layer solid electrolyte composition, the first outer layer solid electrolyte composition, and the second outer layer solid electrolyte composition within these ranges can improve the balance between the strength and lithium-ion conductivity of the solid electrolyte layer 30. From the viewpoint of improving the lithium-ion conductivity of the solid electrolyte layer 30, the binder content ratio in the inner layer solid electrolyte composition may be within the range of 3 to 8% by mass. From the viewpoint of improving the strength of the solid electrolyte layer 30, the binder content ratio in the inner layer solid electrolyte composition may be within the range of 10 to 20% by mass.

In the present embodiment, the solid electrolyte material contained in the inner layer solid electrolyte composition has a smaller average particle size than the solid electrolyte materials contained in the first and second outer layer solid electrolyte compositions. The solid electrolyte materials of a smaller particle size allows for filling a larger number of particles per unit volume, thus can be easily filled into the porous base material. Therefore, by reducing the average particle size of the solid electrolyte material contained in the inner layer solid electrolyte composition, the solid electrolyte material can fill into the porous base material of the inner layer 31 at high density. However, a smaller average particle size tends to reduce lithium-ion conductivity due to increased contact points between particles per unit volume. Thus, by increasing the average particle size of the solid electrolyte material contained in the first and second outer layer solid electrolyte compositions, the ion conductivity of the first outer layer 32 and the second outer layer 33 can be improved. The average particle size of the solid electrolyte material contained in the inner layer solid electrolyte composition may be within the range of 0.5 to 1.5 μm or the range of 0.5 to 1.0 μm. Moreover, the average particle size of the solid electrolyte material contained in the first and second outer layer solid electrolyte compositions may be within the range of 2.0 to 10.0 μm or the range of 2.0 to 5.0 μm. The particle size of the solid electrolyte material is the largest diameter of the solid electrolyte material measured from a cross-sectional SEM (Scanning Electron Microscope) photograph of the solid electrolyte layer 30, and the average particle size is the number average.

The particle size distribution of the solid electrolyte material contained in the inner layer solid electrolyte composition may have a peak in the region where the particle diameter is 1 μm or less. The particle size distribution may be based on the number of the largest diameters of the solid electrolyte material measured from a cross-sectional SEM photograph of the solid electrolyte layer 30. In this case, the inner layer solid electrolyte composition, containing a large number of solid electrolyte material fine particles with a particle diameter of 1 μm or less, can be easily filled into the porous base material of the inner layer 31. Therefore, the strength of the solid electrolyte layer 30 is enhanced. The particle size distribution of the solid electrolyte materials contained in the first and second outer layer solid electrolyte compositions may have a peak in a region where the particle diameter is 1 μm or less and a peak in a region where the particle diameter is 3 μm or more. In this case, the first and second outer layer solid electrolyte compositions, containing both fine particles of solid electrolyte material with a particle diameter of 1 μm or less and coarse particles of solid electrolyte material with a particle diameter of 3 μm or more, can easily densify the first and second outer layers 32 and 33 due to the presence of fine particles between the coarse particles. Thus, the lithium-ion conductivity of the solid electrolyte layer 30 is improved. The upper limit of the particle diameter of the solid electrolyte material contained in the first and second outer layers 32 and 33 is less than or equal to the thickness of the first and second outer layers 32 and 33.

The all-solid-state battery 1 can be manufactured in the following way, for example. A solid electrolyte sheet (solid electrolyte layer 30), in which the first outer layer 32, the inner layer 31, and the second outer layer 33 are stacked in this order, is placed on a positive electrode sheet (positive electrode 10), in which the positive electrode layer 11 and the positive electrode current collector 12 are stacked such that the first outer layer 32 of the solid electrolyte sheet comes into contact with the positive electrode layer 11 of the positive electrode sheet. Subsequently, a negative electrode sheet (negative electrode 20), in which the negative electrode layer 21 and the negative electrode current collector 22 are stacked, is placed on the solid electrolyte sheet such that the negative electrode layer 21 of the negative electrode sheet comes into contact with the solid electrolyte sheet. Thereafter, press bonding is conducted. High-temperature press bonding exceeding 200° C. may be performed for the press bonding.

The solid electrolyte sheet can be manufactured using, for example, a porous base material, an inner layer forming slurry for forming the inner layer 31, and an outer layer forming slurry for forming the first and second outer layers, according to the following methods (1) to (3). Both the inner layer forming slurry and the outer layer forming slurry contain a solvent, a solid electrolyte, and a binder. The inner layer forming slurry contains a higher amount of binder than the outer layer forming slurry.

### (1) Impregnation (Dip) Method

The porous base material is impregnated in the inner layer forming slurry, then lifted out of the inner layer forming slurry and dried to form an inner layer member having a porous base material (inner layer 31) filled with the inner layer solid electrolyte composition. Next, the obtained inner layer member is impregnated in the outer layer forming slurry, then lifted out of the outer layer forming slurry and dried to form outer layers (first outer layer 32, second outer layer 33) on both sides of the inner layer 31 of the inner layer member.

### (2) Coating Method

The outer layer forming slurry is coated on a support sheet and dried to form the first outer layer 32. Next, the inner layer forming slurry is coated on the first outer layer 32, then a porous base material is placed on the coated layer of the inner layer forming slurry, allowing the porous base material to absorb the coated layer, followed by drying to form a porous base material (inner layer 31) filled with the inner layer solid electrolyte composition. Then, the outer layer forming slurry is coated on the inner layer 31 and dried to form the second outer layer 33. Aluminum foil or stainless-steel foil can be used as the support sheet. The coating method for the outer layer forming slurry and the inner layer forming slurry can, for example, utilize a die coater method.

### (3) Transfer Method

An inner layer sheet having the inner layer 31 filled with the inner layer solid electrolyte composition in the porous base material is prepared. Also, an outer layer transfer sheet with a releasable outer layer (first outer layer 32, second outer layer 33) formed on a support sheet is prepared. The inner layer sheet can be obtained as follows: a porous base material is impregnated in the inner layer forming slurry, then lifted out of the inner layer forming slurry and dried, or the inner layer forming slurry is coated on a porous base material and then dried. The outer layer transfer sheet can be obtained by coating the outer layer forming slurry on a support sheet and then drying. Aluminum foil or stainless-steel foil can be used as the support sheet. The surface on the outer layer side of the outer layer transfer sheet is placed on both sides of the inner layer sheet, the outer layers (first outer layer 32, second outer layer 33) are transferred to both sides of the inner layer 31 by pressing, integrated, and then the support sheet is peeled off and removed.

(1) The impregnation method allows for easier reduction of the binder amount, as compared to the (2) coating method and the (3) transfer method. On the other hand, the (2) coating method and the (3) transfer method allow for easier adjustment of the film thickness of the outer layers (first outer layer 32, second outer layer 33), as compared to the (1) impregnation method.

In the all-solid-state battery 1 according to the present embodiment, the solid electrolyte layer 30, containing the inner layer solid electrolyte composition in the inner layer 31 with a high binder content ratio, exhibits high adhesion to the porous base material of the inner layer 31, making it less prone to cracking. On the other hand, the first outer layer solid electrolyte composition contained in the first outer layer 32 and the second outer layer solid electrolyte composition contained in the second outer layer 33 each have a low binder content ratio, thus improving the ion conductivity.

Additionally, the inner layer solid electrolyte composition, having a smaller average particle size of solid electrolyte material, is filled into the porous base material of the inner layer 31 more easily and densely, enhancing the strength and crack prevention effect of the solid electrolyte layer 30. Furthermore, the first and second outer layer solid electrolyte compositions each having a larger average particle size of the solid electrolyte material, enhances the lithium-ion conductivity of the solid electrolyte layer 30. Therefore, the solid electrolyte layer 30 improves in strength, suppresses crack formation, and enhances ion conductivity. Moreover, the all-solid-state battery 1 of the present embodiment, having the above-mentioned solid electrolyte layer 30, exhibits improved long-term stability and charge-discharge efficiency.

While specific embodiments of the present invention have been described, it should be understood that the invention is not limited to these embodiments and may be modified or improved within the scope of the objectives of the invention. For example, in the embodiment described above, the method for manufacturing the all-solid-state battery 1 has been exemplified in which the layers are sequentially stacked, and press-bonded into a one-piece laminate. However, this is a non-limiting example. For example, the all-solid-state battery 1 may be manufactured in the following manner. First, a positive electrode sheet, in which a positive electrode layer 11 and a positive electrode current collector 12 are stacked, is press-bonded at the positive electrode layer 11 to a first outer sheet, thereby preparing a positive electrode-first outer layer-laminate sheet. A negative electrode sheet, in which a negative electrode layer 21 and a negative electrode current collector 22 are stacked, is press-bonded at the negative electrode layer 21 to a second outer sheet, thereby preparing a negative electrode-second outer layer-laminate sheet. Next, a first outer layer 32 of the positive electrode-first outer layer-laminate sheet is press-bonded to one surface of an inner layer sheet, and a second outer layer 33 of the negative electrode-second outer layer-laminate sheet is press-bonded to the other surface of the inner layer sheet. As a result, an electrode laminate sheet is obtained in which the positive electrode sheet, the solid electrolyte sheet, and the negative electrode sheet are stacked in this order. The inner layer solid electrolyte composition of the inner layer sheet may have a binder content ratio within 10 to 20% by mass. The solid electrolyte contained in the inner layer solid electrolyte composition may have an average particle size within the range of 0.5 to 1.0 μm. The inner layer sheet may have a thickness within the range of 5 to 15 μm. The outer layer solid electrolyte composition of the first outer layer sheet and that of the second outer layer sheet may each have a binder content ratio within 5 to 20% by mass. The solid electrolyte contained in the outer layer solid electrolyte composition may have an average particle size within the range of 2.0 to 5.0 μm. The first and second outer layer sheets may each have a thickness within the range of 5 to 20 μm.

### EXAMPLES

### Example 1

### (Preparation of Solid Electrolyte Sheet)

An inner layer forming slurry was prepared by mixing 46 parts by mass of solvent, 51 parts by mass of fine powder of sulfide-based solid electrolyte (average particle size: 0.7 μm), and 3 parts by mass of a styrene butadiene rubber (SBR)-based binder. Additionally, an outer layer forming slurry was prepared by mixing 46 parts by mass of solvent, 10.5 parts by mass of fine powder of sulfide-based solid electrolyte (average particle size: 0.7 μm), 41.9 parts by mass of coarse powder of sulfide-based solid electrolyte (average particle size: 3.0 μm), and 1.6 parts by mass of SBR-based binder.

A non-woven fabric (material: PET, thickness: 10 μm, porosity: 75%, average fiber diameter: 3.0 μm) was impregnated in the inner layer forming slurry, then lifted out of the inner layer forming slurry and dried. Thus, an inner layer member filled with the inner layer solid electrolyte composition containing the fine particles and binder of the sulfide-based solid electrolyte in the non-woven fabric was prepared. The thickness of the obtained inner layer member was 30 μm. The obtained inner layer member was then impregnated in the outer layer forming slurry, lifted out of the outer layer forming slurry and dried. Thus, a three-layer structured solid electrolyte sheet was prepared, with outer layers (thickness: 20 μm) containing both fine and coarse powder of sulfide-based solid electrolyte and binder on both surfaces of the inner layer.

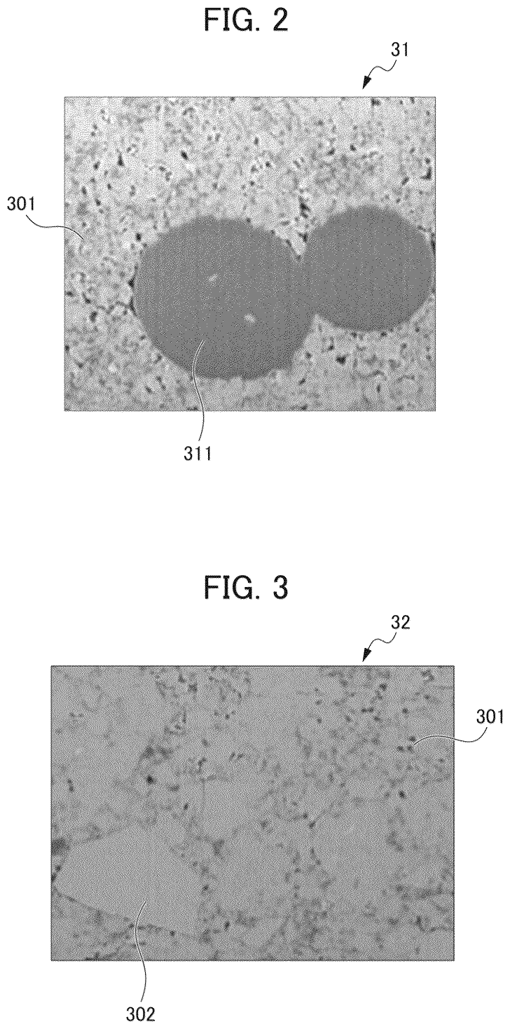

The cross section of the obtained solid electrolyte sheet was observed using a scanning electron microscope (SEM). FIG. 2 illustrates a cross-sectional SEM photograph of the inner layer of the solid electrolyte sheet, and FIG. 3 illustrates a cross-sectional SEM photograph of the first outer layer of the solid electrolyte sheet. From the SEM photograph in FIG. 2, it was confirmed that, in the inner layer 31, fine particles 301 of the sulfide-based solid electrolyte closely adhere around the PET fibers 311 of the non-woven fabric, and the fine particles 301 of the sulfide-based solid electrolyte are densely filled inside the non-woven fabric. Also, from the SEM photograph in FIG. 3, it was confirmed that, in the first outer layer 32, the fine particles 301 of the sulfide-based solid electrolyte are interspersed between coarse particles 302 of the sulfide-based solid electrolyte, thereby forming a layer of the sulfide-based solid electrolyte.

### Example 2

An inner layer forming slurry was prepared by mixing solvent, fine powder of sulfide-based solid electrolyte (average particle size: 0.7 μm), and a SBR-based binder in appropriate proportions such that the SBR-based binder was contained at a content ratio of 3% by mass in the solid content. A non-woven fabric (material: PET, thickness: 10 μm, porosity: 75%, average fiber diameter: 3.0 μm) was impregnated in the inner layer forming slurry, then lifted out of the inner layer forming slurry. The non-woven fabric having the inner layer forming slurry adhering thereto was dried, thereby preparing an inner layer member having a thickness of 30 μm.

An outer layer forming slurry was prepared by mixing solvent, coarse powder of sulfide-based solid electrolyte (average particle size: 3.0 μm), and a SBR-based binder in appropriate proportions such that the SBR-based binder was contained at a content ratio of 1.6% by mass in the solid content. The inner layer member was impregnated in the outer layer forming slurry, and then lifted out of the outer layer forming slurry. The inner layer member having the outer layer forming slurry adhering thereto was dried, thereby preparing a solid electrolyte sheet including an inner layer having a thickness of 30 μm and first and second outer layers each having a thickness of 20 μm thickness.

### Examples 3 and 4

A solid electrolyte sheet was prepared in the same manner as in Example 2, except that the inner layer had a thickness shown in Table 1 below by way of adjustment of adhesion of the inner layer forming slurry and the outer layer forming slurry.

### Comparative Example 1

A solid electrolyte sheet was prepared in the same manner as in Example 2, except that: a slurry (which was the same as the outer layer forming slurry in Example 2) containing the coarse powder of sulfide-based solid electrolyte (average particle size: 3.0 μm) and the SBR-based binder at a content ratio of 1.6% by mass in the solid content was used as an inner layer forming slurry; and a slurry (which was the same as the inner layer forming slurry in Example 2) containing the fine powder of sulfide-based solid electrolyte (average particle size: 0.7 μm) and the SBR-based binder at a content ratio of 3.0% by mass in the solid content was used as an outer layer forming slurry.

### [Evaluation]

### (1) Observation of Cross Sections

A cross section of each of the solid electrolyte sheets of Examples 1 to 3 was observed using a SEM. As a result, it was confirmed that the fine particles of sulfide-based solid electrolyte are densely filled inside the non-woven fabric constituting the inner layer. It was also confirmed that, in the first outer layer, the fine particles 301 of the sulfide-based solid electrolyte are interspersed between the coarse particles 302 of the sulfide-based solid electrolyte, thereby forming a layer of the sulfide-based solid electrolyte.

### (2) Performance Evaluation of All-Solid-State Battery Cells

All-solid-state battery cells including the solid electrolyte sheets described above were produced in accordance with the following process.

### [Preparation of Positive Electrode Sheet]

An aluminum foil having a thickness of 12.0 μm was provided as a positive electrode current collector. A positive electrode active material was prepared by mixing 60.0 parts by mass of a lithium nickel cobalt manganese composite oxide (NCM 622) as a positive electrode active material, 35.8 parts by mass of sulfide-based solid electrolyte as a solid electrolyte, 2.9 parts by mass of acetylene black (DENKA BLACK Li-100, available from Denka Company Limited) as a conductive aid, and 1.3 parts by mass of a styrene butadiene rubber (SBR)-based binder. The resultant mixture was dispersed in solvent, thereby forming a positive electrode active material slurry. The positive electrode active material slurry was applied to both surfaces of the positive electrode current collector using a bar coater such that a coating weight of 27.4 mg/cm² was achieved in a dried state. The applied slurry was then dried to form a positive electrode layer. In this way, a positive electrode sheet was produced.

### [Preparation of Negative Electrode Sheet]

A copper foil having a thickness of 10 μm was provided as a negative electrode current collector. A metal lithium foil having a thickness of 6.5 μm was stacked as a negative electrode layer on a surface of the copper foil, thereby forming a negative electrode sheet.

### [Preparation of All-Solid-State Battery Cells]

The positive electrode sheet, the solid electrolyte sheet, and the negative electrode sheet prepared in the above-described manner were cut into a size of 120 mm×30 mm. The resultant positive electrode pieces, solid electrolyte pieces, and negative electrode pieces were stacked and press-bonded to form electrode laminates. All-solid-state battery cells including the electrode laminates were produced.

### [Cell Charge-Discharge Test]

The all-solid-state battery cells produced in the above described manner were subjected to a charge-discharge test in the range from 2.65 V to 4.3 V. The battery cells having a second charge/discharge capacity equal to or more than 95% of a first charge/discharge capacity were determined as “accepted”. The battery cells having a second charge/discharge capacity less than 95% of a first charge/discharge capacity were determined as “rejected”. The results are shown in Table 1.

### [Cell Resistance]

After the charge/discharge test, cell resistance of the all-solid-state battery cells was measured in a state in which the battery cells had a state of charge (SOC) of 50% due to charging. The results are shown in Table 1.

TABLE 1

| | | | | | Comparative |
|---|---|---|---|---|---|
| | | Example 2 | Example 3 | Example 4 | Example 1 |
| First | Binder Content Ratio | 1.6 | 1.6 | 1.6 | 3.0 |
| Outer | (% by mass) | | | | |
| Layer | Average Particle Size | 3.0 | 3.0 | 3.0 | 0.7 |
| | of Solid Electrolyte | | | | |
| | (μm) | | | | |
| | Thickness | 20 | 5 | 7 | 20 |
| | (μm) | | | | |
| Inner | Binder Content Ratio | 3.0 | 3.0 | 3.0 | 1.6 |
| Layer | (% by mass) | | | | |
| | Average Particle Size | 0.7 | 0.7 | 0.7 | 3.0 |
| | of Solid Electrolyte | | | | |
| | (μm) | | | | |
| | Thickness | 30 | 25 | 10 | 30 |
| | (μm) | | | | |
| Second | Binder Content Ratio | 1.6 | 1.6 | 1.6 | 3.0 |
| Outer | (% by mass) | | | | |
| Layer | Average Particle Size | 3.0 | 3.0 | 3.0 | 0.7 |
| | of Solid Electrolyte | | | | |
| | (μm) | | | | |
| | Thickness | 20 | 5 | 7 | 20 |
| | (μm) | | | | |
| Evaluation | Charge-Discharge | Accepted | Accepted | Accepted | Rejected |
| | Efficiency in Second | | | | |
| | Cycle | | | | |
| | Cell Resistance | 33.1 | 25.6 | 19.5 | — |
| | (Ω · cm²) | | | | |

The results shown in Table 1 demonstrate that the all-solid-state battery cells including the solid electrolyte sheets of Examples 2 to 4, of which the binder content and the average particle size of the solid electrolyte material are within the ranges of the present invention, have high charge-discharge efficiency in the second cycle and low cell resistance. In particular, it can be appreciated that the all-solid-state battery cells including the solid electrolyte sheets of Examples 3 and 4, in which the thickness of the inner layer is 25 μm or less and the thicknesses of the first and second outer layers are 7 μm or less, have further reduced cell resistance. On the other hand, the all-solid-state battery cell including the solid electrolyte sheet of Comparative Example 1, in which the inner layer solid electrolyte composition has a low binder content and the solid electrolyte material contained in the inner layer solid electrolyte composition has a large average particle size, experienced a short-circuit at the time of the second cycle, and could not be charged or discharged.

### Example 5

As a first outer layer sheet and a second outer layer sheet, a sheet having a thickness of 7 μm and containing coarse powder of sulfide-based solid electrolyte (average particle size: 3.0 μm) and a SBR-based binder at a SBR-based binder content ratio of 5.0% by mass was prepared. As an inner layer sheet, a sheet having a thickness of 10 μm and containing a fine powder of sulfide-based solid electrolyte (average particle size: 0.7 μm) and a SBR-based binder at a SBR-based binder content of 10% by mass was prepared.

The positive electrode sheet prepared in the performance evaluation of the all-solid-state battery cells was press-bonded at the positive electrode layer to the first outer layer sheet, whereby a positive electrode-first outer layer-laminate sheet was prepared. Likewise, the negative electrode sheet prepared in the performance evaluation of the all-solid-state battery cells was press-bonded at the negative electrode layer 21 to the second outer layer sheet, whereby a negative electrode-second outer layer-laminate sheet was prepared. Next, the first outer layer of the positive electrode-first outer layer-laminate sheet was bonded to one surface of the inner layer sheet, and the second outer layer of the negative electrode-second outer layer-laminate sheet was bonded to the other surface of the inner layer sheet, whereby an electrode laminate sheet was obtained in which the positive electrode sheet, the solid electrolyte sheet, and the negative electrode sheet were stacked in this order. The obtained electrode laminate sheet was cut into a size of 20 mm×30 mm, and an all-solid-state battery cell including the electrode laminate was produced.

### Example 6 and Comparative Examples 2 and 3

All-solid-state battery cells were produced in the same manner as in Example 5, except that: a sheet containing sulfide-based solid electrolyte having an average particle size shown in Table 2 below and a SBR-based binder at a SBR-based binder content ratio shown in Table 2 was used as a first outer layer sheet and a second outer layer sheet; and a sheet containing sulfide-based solid electrolyte having an average particle size shown in Table 2 and a SBR-based binder at a SBR-based binder content shown in Table 2 was used as an inner layer sheet.

### [Evaluation]

The all-solid-state battery cells of Examples 5 and 6 and Comparative Examples 2 and 3 were evaluated in the same manner as in the above-described performance evaluation of the all-solid-state battery cells. The results are shown in Table 2 below.

TABLE 2

| | | | | Comparative | Comparative |
|---|---|---|---|---|---|
| | | Example 5 | Example 6 | Example2 | Example3 |
| First | Binder Content Ratio | 5.0 | 18 | 10 | 20 |
| Outer | (% by mass) | | | | |
| Layer | Average Particle Size | 3.0 | 3.0 | 0.7 | 0.7 |
| | of Solid Electrolyte | | | | |
| | (μm) | | | | |
| | Thickness | 7 | 7 | 7 | 7 |
| | (μm) | | | | |
| Inner | Binder Content Ratio | 10 | 20 | 5.0 | 18 |
| Layer | (% by mass) | | | | |
| | Average Particle Size | 0.7 | 0.7 | 3.0 | 3.0 |
| | of Solid Electrolyte | | | | |
| | (μm) | | | | |
| | Thickness | 10 | 10 | 10 | 10 |
| | (μm) | | | | |
| Second | Binder Content Ratio | 5.0 | 18 | 10 | 20 |
| Outer | (% by mass) | | | | |
| Layer | Average Particle Size | 3.0 | 3.0 | 0.7 | 0.7 |
| | of Solid Electrolyte | | | | |
| | (μm) | | | | |
| | Thickness | 7 | 7 | 7 | 7 |
| | (μm) | | | | |
| Evaluation | Charge-Discharge | Accepted | Accepted | Accepted | Accepted |
| | Efficiency in Second | | | | |
| | Cycle | | | | |
| | Cell Resistance | 37.3 | 49.2 | 56.1 | 75.7 |
| | (Ω · cm²) | | | | |

The results shown in Table 2 demonstrate that the all-solid-state battery cells including the solid electrolyte sheets of Examples 5 and 6, of which the binder content and the average particle size of the solid electrolyte material are within the ranges of the present invention, have high charge-discharge efficiency in the second cycle and low cell resistance. On the other hand, the all-solid-state battery cells including the solid electrolyte sheets of Comparative Examples 2 and 3, in which the inner layer solid electrolyte composition has a low binder content and the solid electrolyte material contained in the inner layer solid electrolyte composition has a large average particle size, have high cell resistance while having high charge-discharge efficiency in the second cycle.

### PREFERRED MODE FOR CARRYING OUT THE INVENTION

1: all-solid-state battery
10: positive electrode
11: positive electrode layer
12: positive electrode current collector
20: negative electrode
21: negative electrode layer
22: negative electrode current collector
30: solid electrolyte layer
31: inner layer
32: first outer layer
33: second outer layer
301: fine particles of sulfide-based solid electrolyte
302: coarse particles of sulfide-based solid electrolyte
311: PET fibers of non-woven fabric

What is claimed is:

1. A solid electrolyte sheet, comprising:
an inner layer;
a first outer layer stacked on one surface of the inner layer; and
a second outer layer stacked on another surface of the inner layer, wherein
the inner layer contains a porous base material and an inner layer solid electrolyte composition filled in the porous base material, the inner layer solid electrolyte composition containing a solid electrolyte material and a binder,
the first outer layer includes a first outer layer solid electrolyte composition containing a solid electrolyte material and a binder,
the second outer layer includes a second outer layer solid electrolyte composition containing a solid electrolyte material and a binder,
the inner layer solid electrolyte composition has a binder content ratio that is higher than a binder content ratio of the first outer layer solid electrolyte composition and higher than a binder content ratio of the second outer layer solid electrolyte composition, and
the solid electrolyte material contained in the inner layer solid electrolyte composition has an average particle size that is smaller than an average particle size of the solid electrolyte material contained in the first outer layer solid electrolyte composition and smaller than an average particle size of the solid electrolyte material contained in the second outer layer solid electrolyte composition.

2. The solid electrolyte sheet according to claim 1, wherein
the binder content ratio of the first outer layer solid electrolyte composition and the binder content ratio of the second outer layer solid electrolyte composition are each within a range of 1/10 to 9/10 of the binder content ratio of the inner layer solid electrolyte composition.

3. The solid electrolyte sheet according to claim 2, wherein
the binder content ratio of the first outer layer solid electrolyte composition and the binder content ratio of the second outer layer solid electrolyte composition are each within a range of 3/10 to 6/10 of the binder content ratio of the inner layer solid electrolyte composition.

4. The solid electrolyte sheet according to claim 1, wherein
the binder content ratio of the inner layer solid electrolyte composition is within a range of 3 to 20% by mass.

5. The solid electrolyte sheet according to claim 4, wherein
the binder content ratio of the inner layer solid electrolyte composition is within a range of 3 to 9% by mass.

6. The solid electrolyte sheet according to claim 5, wherein
the inner layer has a thickness within a range of 10 μm to 25 μm.

7. The solid electrolyte sheet according to claim 4, wherein
the binder content ratio of the inner layer solid electrolyte composition is within a range of 10 to 20% by mass.

8. The solid electrolyte sheet according to claim 1, wherein
a particle size distribution of the solid electrolyte material contained in the inner layer solid electrolyte composition has a peak in a region where a particle diameter is 1 μm or less, and a particle size distribution of the solid electrolyte material contained in the first outer layer solid electrolyte composition and a particle size distribution of the solid electrolyte material contained in the second outer layer solid electrolyte composition each have a peak in a region where a particle diameter is 1 μm or less and a peak in a region where a particle diameter is 3 μm or more.

9. The solid electrolyte sheet according to claim 1, wherein
the thickness of the inner layer is within a range of 2 μm to 30 μm, and
the first outer layer and the second outer layer each have a thickness within a range of ⅕ to 2 times the thickness of the inner layer.

10. The solid electrolyte sheet according to claim 9, wherein
the first outer layer and the second outer layer are each thinner than the inner layer.

11. The solid electrolyte sheet according to claim 10, wherein
the thickness of the first outer layer and the thickness of the second outer layer are each within a range of ⅕ to ⅘ times the thickness of the inner layer.

12. The solid electrolyte sheet according to claim 9, wherein
the thickness of the inner layer is within a range of 10 μm to 25 μm.

13. An all-solid-state battery, comprising:
a positive electrode;
a negative electrode; and
a solid electrolyte layer arranged between the positive electrode and the negative electrode, wherein
the solid electrolyte layer consists of the solid electrolyte sheet according to claim 1, the first outer layer is arranged in contact with the positive electrode, and the second outer layer is arranged in contact with the negative electrode.
